(19) United States
(12) Patent Application Publication
(10) Pub. No.: US 2007/0070823 A1
(43) Pub. Date: Mar. 29, 2007

(54) Device for the connection of an end part of a band to a stationary part

(76) Inventor: Wolfgang Sima, Keutschach (AT)

Correspondence Address: DICKSTEIN SHAPIRO LLP, 1825 EYE STREET NW, Washington, DC, 20006-5403, US

(21) Appl. No.: 11/526,004

(22) Filed: Sep. 25, 2006

(30) Foreign Application Priority Data
Sep. 29, 2005 (AT) GM 659/2005

(51) Int. Cl. G04B 37/00

(52) U.S. Cl. 368/282

(57) ABSTRACT

A device for easily and quickly connecting an end part (4) of a band (3) to a further part (1), in particular a wristband (3) to a further part (1) such as a watchband (3) to a watch casing (1), wherein a pin (2) arranged at the end part (4) of the band (3) and extending, with its longitudinal axis, transversely to the longitudinal direction of the band (3) can be engaged with at least one recess (6) of the rigid part (1), is characterized in that the end part (4) is detachably connectable to the band (3) by means of a form-fitting connection (10, 22) to be operated by hand.

### BACKGROUND OF THE INVENTION

The invention relates to a device for the connection of an end part of a band to a further part, in particular a wristband to a further part such as a watchband to a watch casing, wherein a pin arranged at the end part of the band and extending, with its longitudinal axis, transversely to the longitudinal direction of the band can be engaged with at least one recess of the rigid part.

For the attachment of a watchband to a watch casing, it is known to stick a pin, at the end part of the watchband, which end part is adjacent to the watch casing, through a recess of said end part, which pin engages recesses of lugs or horns, respectively, projecting from the watch casing. Such a pin is often configured as a tubular element in which a spring is housed which presses against two pegs disposed at the ends of the tubular element, wherein at least one of said pegs is arranged so as to be movable in the tubular element so that it becomes possible for the pin to spring into the recesses of the horns of the watch casing. As a rule, the end part of the watchband is pivotable about the axis of the pin relative to the watch casing, the more so as usually a clearance is provided between the end part of the band and the watch casing (cf. DE 2 245 202 A).

The attachment of a watchband to a watch casing, with a resiliently deformable pin penetrating an end part of the watchband, is known, for instance, from DE 2 249 827 A, wherein, also in this case, a clearance permitting a swivelling movement is provided between the end part of the watchband and the watch casing.

Should one wish to replace a watchband, a tool is required for the known fastening mechanisms as described above. In case of a spring pin according to DE 2 245 202 A, said pin must be compressed to such an extent that the watchband can be detached from the watch casing. This is cumbersome and necessitates a very precise tool which often is not readily available to the wearer of a watch. In addition, upon replacing a watchband, persons not skilled in the art could easily damage said watchband or the spring pin so that one is usually obliged to seek a watchmaker's help for replacing a watchband.

According to fashion trends, watch casings are often sold together with several watchbands designed differently in terms of colour and/or appearance. This poses the problem that the watchband is easily separable from the watch casing and replaceable by a different one, whereby, for this manipulation, it is not necessary to seek a watchmaker's help and, furthermore, no tool should be required.

### SUMMARY OF THE INVENTION

Thus, the invention aims at providing a device of the initially described kind which is easily operable so that a part, for example a watch casing, can easily and quickly be connected to different bands such as watchbands, which, for example, are colour coordinated with the clothes, with one hand movement even by persons not skilled in the art of watchmaking. Furthermore, the device is supposed to be robust as well as easy to manufacture and assemble.

According to the invention, this object is achieved in that the end part is detachably connectable to the band by means of a form-fitting connection, preferably a snap connection, to be operated by hand, wherein, according to a preferred embodiment, the form-fitting connection comprises two lugs, preferably key heads, which are lockable against one another and whose moving direction is provided in parallel to the pin, which lugs are engageable, in each case, with a lug notch arranged at the end part of the band or on the band.

Particularly easy mounting of the band to the rigid part is provided if guide surfaces and opposite guide surfaces corresponding to each other and preferably designed with dovetail cross-sections are provided both at the end part and on the band, with the guide surfaces advantageously being oriented roughly vertically to the band plane.

According to a preferred embodiment, the lugs are provided in the end part, wherein the lugs are suitably in a moved-apart state if the end part is connected to the band and wherein, furthermore, a spring, in particular a helical spring, pressing the lugs apart is provided in the end part.

An optically appealing device is characterized in that the end part comprises a retaining part receiving the lugs as well as optionally the guide surfaces, which retaining part is narrower than the width of the band and is insertable into a recess of the band exhibiting the lug notches as well as optionally the opposite guide surfaces and encompassing the retaining part in a U-shaped manner.

A particularly simple manufacture of the device is provided if the guide surfaces of the band as well as the lug notch and optionally the lugs, respectively, are housed in a casing which is cast integral with the band or glued or welded to the same.

Particularly easy operation of the device is provided if the lugs are provided with actuating extensions oriented toward the bottom side of the end part or of the band, respectively, and preferably projecting beyond the same for detaching the lugs from the lug notches.

In order to let the band appear as a unit with the end part fixed to the rigid part, the band and/or the casing is/are suitably provided with a cover overlapping the end part.

### BRIEF DESCRIPTION OF THE DRAWINGS

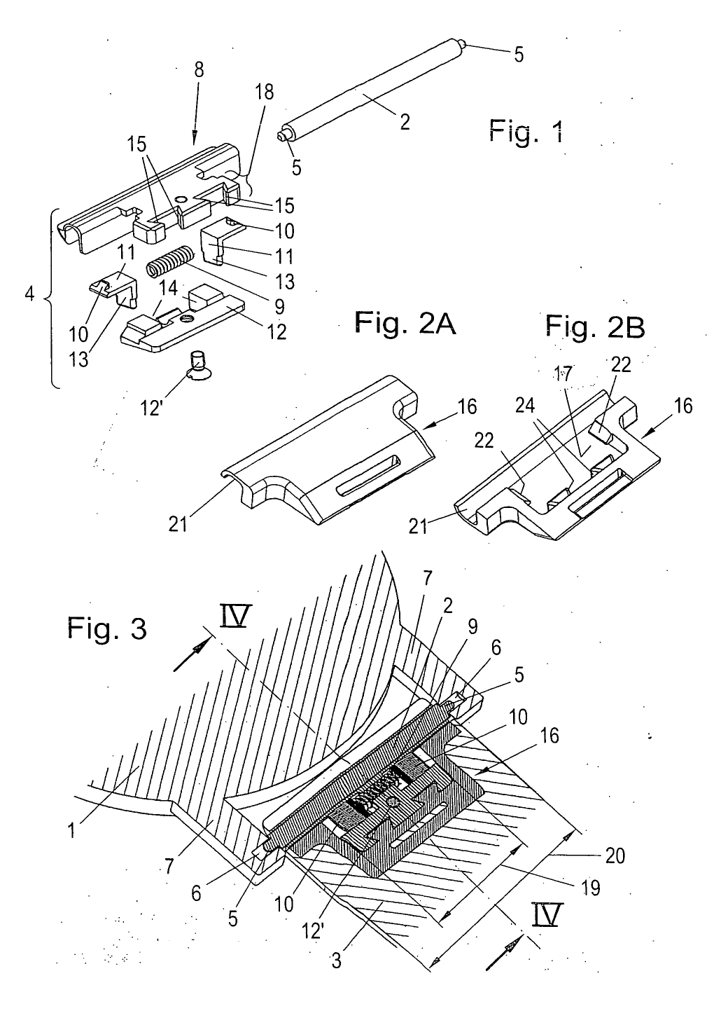

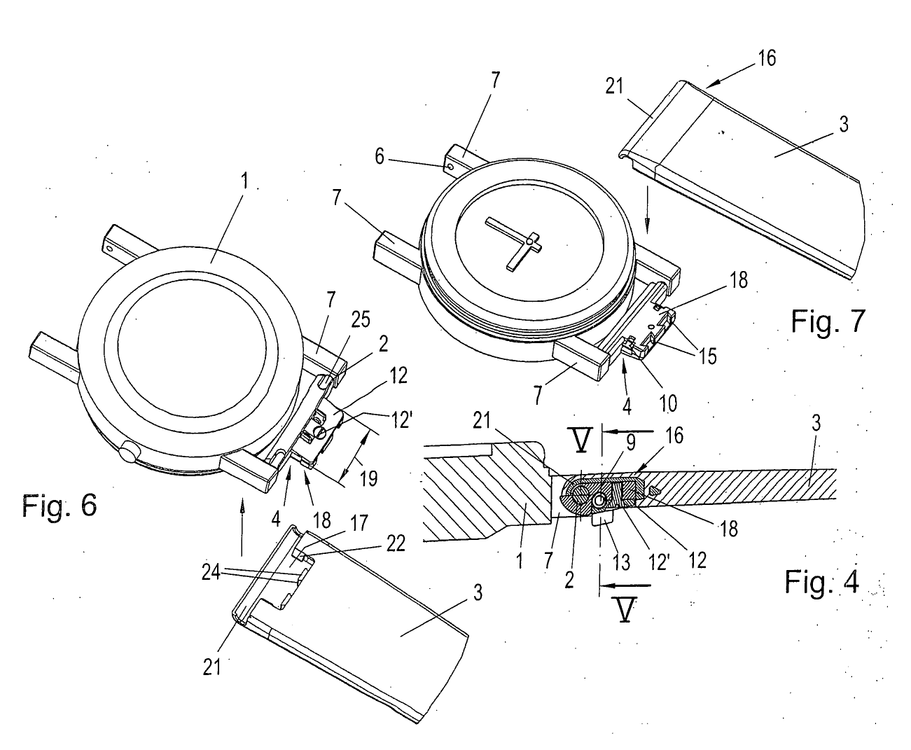

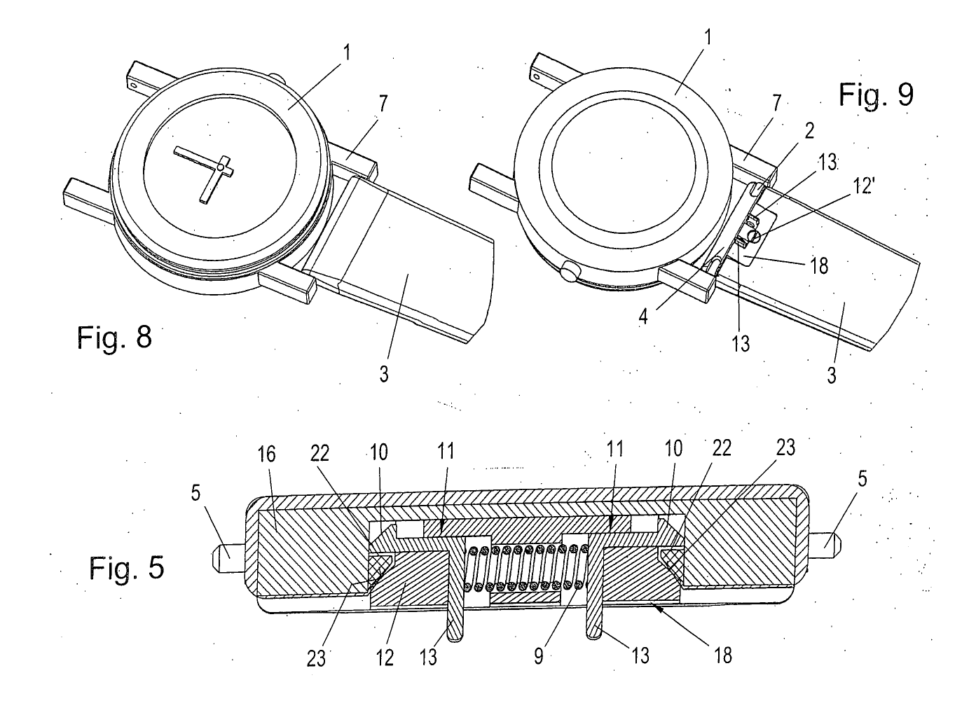

Below, the invention is illustrated in further detail by way of an exemplary embodiment illustrated in the drawing, wherein FIG. 1 shows an exploded view of an end part fixable to a watch casing, FIGS. 2A and 2B show a casing connectable to a band end, once in top view (FIG. 2A) and once in bottom view (FIG. 2B), and FIG. 3 shows a cross-section through a device that has been assembled and connected to a watch casing, wherein the cross-section is guided in parallel to the band plane roughly in the centre of the same. FIG. 4 shows a longitudinal section taken along line IV/IV of FIG. 3, and FIG. 5 shows a section taken along line V/V of FIG. 4, but on an enlarged scale. FIGS. 6 and 7 illustrate a watchband detached from the watch casing, once in bottom view (FIG. 6) and once in top view (FIG. 7), FIGS. 8 and 9 show the watchband attached to the watch casing, once in top view (FIG. 8) and once in bottom view (FIG. 9).

### DETAILED DESCRIPTION OF THE PREFERRED EMBODIMENT

An end part 4 of the watchband 3, which end part is detachable from a watchband 3, is fixed to a watch casing 1 by means of a pin 2, which preferably is designed as a spring pin, whereby the pin 2 is insertable with its peg-shaped ends 5 into recesses 6 of horns 7 projecting from the watch casing 1, between which horns the end part 4 of the watchband 1 comes to rest. Said end part 4 has a multipart design, as illustrated by the exploded view in FIG. 1. It has a main part 8 surrounding the pin 2, on which main part two lugs 10 are slidably mounted, which can be pressed apart in parallel to the axial direction of the pin 2 by means of a helical spring 9. Preferably, the end part 4 is manufactured from metal; it may also be formed from a synthetic material.

Said lugs 10 are designed as key heads and are provided, in each case, at the ends of an elbow 11. Said elbow penetrates a clamping lug 12 which is fixable to the main part 8 by means of a screw 12, whereby the helical spring 9 is surrounded. The extensions 13 of the elbows 11, which extensions run vertically to the axial direction of the pin 2, are designed as actuating extensions, as will be explained hereinbelow, and project through recesses 14 of the clamping lug 12. The main part 8 of the end part 4 exhibits guide surfaces 15 oriented roughly vertically to the plane of the watchband 3, which form two dovetail cross-sections.

A casing 16, which preferably is manufactured from a synthetic material, is cast (moulded) integral with the end of the watchband 3 or glued or welded to the same, for example, if the watchband 3 is designed as a plastic band. Said casing 16 is provided with a recess 17 into which the part 18 of the main part 8—in the following referred to as retaining part 18—carrying the guide surfaces 15 and the sliding lugs 10 is insertable, with the recess surrounding said retaining part 18—the width 19 of which is dimensioned smaller than the width 20 of the watchband 3—in a U-shaped manner. In order to cover the end part 4 along with the retaining part 18 thereof toward the top side of the watchband 3, the recess 17 is closed toward the top side of the watchband 3 and is provided with a cover 21 designed with an arcuate cross-section, which also covers the pin seat—i.e., the main part 8—of the end part 4.

In the recess 17, lug notches 22 arranged so as to correspond to the lugs 10 are provided, which have a wedge-shaped design and come to rest against opposite wedge surfaces 23 of the clamping lug 12 if the watchband 3 is mounted with the end part 4. Furthermore, opposite guide surfaces 24 arranged so as to correspond to the guide surfaces 15 are provided in the recess, which are also arranged with dovetail-shaped cross-sections.

The watchband 3 is removed from the watch casing by moving the two actuating extensions 13 toward one another against the force of the helical spring 9, whereby the watchband is simultaneously shifted in parallel to the guide surfaces 15.

To allow easy detachment of the pin 2 from the watch casing 1, the pin seat of the end part 4 is provided with recesses 25 oriented downward in the end regions of the main part 8 of the end part 4.

The invention is not limited to the exemplary embodiment illustrated in the drawing but can be modified in various ways. For example, the lugs 10 are not necessarily designed as key heads, although the construction as key heads facilitates the assembly of the end part 4 with the band 3, particularly since, during assembly, the lugs 10 engage with the lug notches 22 independently via their wedge surfaces and the actuating extensions 13 do not have to be operated. Furthermore, the lugs 10 could also be provided on the band 3 rather than at the end part 4. Likewise, the recess 17 provided at the band end could be arranged at the end part 4 and the retaining part 18 could be arranged on the band 3. The watchband 3 can also be formed by link bodies joined together in the manner of a chain. The device according to the invention is not only suitable for connecting a casing 1 to a watchband 3 but can also serve for connecting other parts—e.g. a piece of jewellery—to a band.

1. A device for connecting an end part (4) of a band (3) to a further part (1), in particular a wristband (3) to a further part (1) such as a watchband (3) to a watch casing (1), wherein a pin (2) arranged at the end part (4) of the band (3) and extending, with its. longitudinal axis, transversely to the longitudinal direction of the band can be engaged with at least one recess (6) of the rigid part (1), characterized in that the end part (4) is detachably connectable to the band (3) by means of a form-fitting connection. (10, 22), preferably a snap connection, to be operated by hand.

2. A device according to claim 1, characterized in that the form-fitting connection (10, 22) comprises two lugs (10), preferably key heads, which are movable against one another and whose moving direction is provided in parallel to the pin (2), and which lugs (10) are engageable, in each case, with a lug notch (22) of the counterpiece, in particular of the band (3).

3. A device according to claim 1, characterized in that, for mounting the end part (4) with the band (3), guide surfaces (15) and opposite guide surfaces (24) corresponding to each other and preferably designed with dovetail cross-sections are provided both at the end part (4) and on the band (3).

4. A device according to claim 3, characterized in that the guide surfaces (15) and the opposite guide surfaces (24) are oriented roughly vertically to the band plane.

5. A device according to claim 2 characterized in that the lugs (10) are provided in the end part (4).

6. A device according to claim 5, characterized in that the lugs (10) are in a moved-apart state if the end part (4) is connected to the band (3).

7. A device according to claim 6, characterized in that a spring (9), in particular a helical spring (9), pressing the lugs apart is provided in the end part (4).

8. A device according to claim 6, characterized in that the end part (4) comprises a retaining part (18) receiving the lugs (10) as well as optionally the guide surfaces (15), which retaining part is narrower than the width (20) of the band (3) and is insertable into a recess (17) of the band (3) exhibiting the lug notches (22) as well as optionally the opposite guide surfaces (24) and encompassing the retaining part (18) in a U-shaped manner.

9. A device according to claim 1, characterized in that the guide surfaces (15) of the band (3) as well as the lug notch (22) and optionally the lugs (10), respectively, are housed in a casing (16) which is cast integral with the band (3) or glued or welded to the same or which is cast or moulded integral with the same, respectively.

10. A device according to claim 1, characterized in that the lugs (10) are provided with actuating extensions (13) oriented toward the bottom side of the end part (4) or of the band (3), respectively, and preferably projecting beyond the same for detaching the lugs (10) from the lug notches (22).

11. A device according to claim 1, characterized in that the band (3) and/or the casing (16) is/are provided with a cover (21) overlapping the end part (4).
